(19) United States
(12) Patent Application Publication
(10) Pub. No.: US 2015/0229919 A1
(43) Pub. Date: Aug. 13, 2015

(54) METHOD FOR CALIBRATING THE COLOUR OF A COLOUR MONITOR WITH LED BACKLIGHTING

(71) Applicant: FRAUNHOFER-GESELLSCHAFT ZUR FOERDERUNG DER ANGEWANDTEN FORSCHUNG E.V., Muenchen (DE)

(72) Inventors: Norbert Weber, Weissenohe (DE); Stephan Junger, Bubenreuth (DE); Wladimir Tschekalinskij, Nuernberg (DE)

(21) Appl. No.: 14/422,914

(22) PCT Filed: Aug. 22, 2013
(86) PCT No.: PCT/EP2013/002526

§ 371 Date: Feb. 20, 2015

(30) Foreign Application Priority Data
Aug. 23, 2012 (DE) 10 2012 016 675.3

(51) Int. Cl. H04N 17/02; H04N 9/12; H04N 5/44; H04N 9/73

(52) U.S. Cl. CPC H04N 17/02; H04N 9/73; H04N 9/12; H04N 5/4403; H04N 2005/4428

(57) ABSTRACT

A method for calibrating the colour of a colour monitor with LED backlighting includes at least one area of an image displayed on the colour monitor (1) remotely measured in a spatially resolved manner using a colour sensor (7) configured as an image or line sensor. Deviations of measured colour values from desired colour values are determined in a spatially resolved manner and LED backlighting of the colour monitor (1) is actuated for local correction of the deviations. When the colour sensor (7) is integrated into the remote control (2) of a colour television, the user aims the remote control (2) at the television, and the colour sensor (7) records a test image (3) of the colour television and evaluates it to determine colour corrections. The method makes it possible for the colour of a colour television to be calibrated ex works or in the user's home.

### TECHNICAL FIELD OF APPLICATION

The present invention relates to a method for calibrating the colour of a colour monitor with LED backlighting with the help of a colour sensor.

Colour televisions or other colour monitors with LED backlighting can suffer from colour drift of the LED's over the course of their service life or due to temperature effects. In the case of temperature changes, the LED colour drift is approximately 0.1 nm/K. This means that the image displayed on the colour monitor can appear severely distorted, as the human eye perceives a deviation in wavelength of only 3 nm as a severe colour distortion.

The above problems are caused primarily by variations in the production of LED's which are used as backlighting for colour monitors. These production variations mean that the LED's used can differ from one another locally or sectionally in terms of their temperature-dependent properties and, in addition, can show different ageing effects. Furthermore, local colour distortion may also be caused by an uneven temperature distribution at the backlighting, in which more than 3000 LED's are frequently operating simultaneously. This naturally produces a significantly higher temperature in the centre of the monitor than at the periphery, so that the two areas can produce a different colour deviation.

### STATE OF THE ART

Commercially available television screens are currently usually only calibrated ex works. By contrast, in the case of computer screens the user has the possibility of adjusting the colour. This is achieved by a special three-channel sensor which is mounted on the screen for subsequent or repeated calibration. Using this sensor, the colour portrayed by the colour monitor in a test image is then measured and transferred to the computer for colour adjustment.

A comparable technique for colour televisions is proposed in DE 102009004236 A1, in which the colour sensor is mounted in a corner area of the screen on the edge of the screen and records a measurement screen portion of a few square centimetres. Using this sensor, calibration can then be initiated either automatically or at the pressing of a button with the help of the colour television's remote control, for example. The colour deviation thereby determined is used to calculate correction values by means of which the control unit corrects the colour display of the colour television. By means of a correlation function determined ex works, the correction determined for the measurement screen portion is transferred to the entire image area of the screen.

However, no spatially dependent colour deviations can be identified using these known techniques. Instead, these measuring methods are limited to measuring the colour of a very small portion of the screen. The correction is then carried out for the entire screen in each case based on this measurement. This solution is suitable for devices with lateral lighting in which the light generated laterally by LED's is distributed over the entire screen by means of a special optical system. Any colour deviations in this case are virtually identical over the entire screen area. In the case of colour monitors of the aforementioned kind with LED backlighting, the LED's are, however, distributed in a very large number over the background of the screen, so that locally different colour drifts can occur.

An LCD monitor with LED backlighting is known from US 2011/00285763 A1, in which the LED backlighting comprises an LED panel disposed behind the LCD panel. In order to produce a uniform colour or brightness distribution, all LED's are activated using the same voltage to begin with. The actual colour distribution is then recorded from a given number of pixels using a colour sensor. Correction values for actuating the LED backlighting are calculated from the recorded values, with which correction values a uniform colour or brightness distribution can be created on the monitor.

US 2010/0079365 A1 discloses a method of white balance in direct LED backlighting in which the LED's are activated using given control values and the colour value of the light emitted by the LCD screen is recorded using a camera. The LED control values are altered based on the measured values.

The problem addressed by the present invention is that of specifying a method for the spatially resolved colour calibration of a colour monitor with LED backlighting which can easily be carried out by a user.

### REPRESENTATION OF THE INVENTION

The problem is solved using the method according to patent claim 1. Patent claim 10 specifies a system designed for implementing the method comprising a colour monitor and a colour measuring device. Advantageous embodiments of the method and also of the associated system are the subject-matter of the dependent patent claims or can be inferred from the following description and also from the exemplary embodiment.

With the proposed method for calibrating the colour of a colour monitor, at least one area of an image displayed on the colour monitor is remotely measured in a spatially resolved manner using a colour sensor. The colour sensor in this case is configured as a two-dimensional image sensor or as a line sensor or represents an area of a sensor of this kind, wherein it can record the corresponding area with a measurement in a completely spatially resolved manner. A deviation of a measured colour value from a desired colour value in each case is subsequently determined in a spatially resolved manner and the LED backlighting is actuated for local correction of the respective deviation. During the measurement, the colour sensor preferably records not only an image area, but the entire displayed image in a spatially resolved manner.

The multi-channel colour sensor must be able to distinguish at last four colours in a spatially resolved manner. The pixel may also comprise 4 or more sub-pixels with different colour filters, for example. The colour monitor in this case is preferably actuated for colour calibration in such a way that it displays a test image which is then recorded using the colour sensor. The test image may also be finely structured locally in this case, in order to achieve an optimal colour correction over the entire colour monitor up to the corners of the image.

In a preferred embodiment, the colour sensor is configured in such a way that it records the complete image displayed on the colour monitor in a spatially resolved manner without movement. In this way, the colour calibration of the entire screen can be carried out for example with a single pressing of a button using the colour sensor aimed at the screen. In another embodiment in which only a portion of the image displayed on the colour monitor is recorded, for example when using a line sensor as the colour sensor, this is then moved accordingly in order to scan the entire screen or record portions of the entire image area, from which an image recording of the complete image displayed on the colour monitor is then assembled for calibration.

With the proposed method, the measured values of the colour sensor, for example the one or multiple image recordings with corresponding colour information, can be transferred to the colour monitor and local colour deviations determined in an evaluation device in the colour monitor. In another embodiment, deviations can also be determined in an evaluation device which is arranged in a mobile unit containing the colour sensor and then transferred to the colour monitor for colour correction of the LED backlighting. The transfer preferably takes place wirelessly in this case, by means of infrared (IR) or radio, for example.

With the proposed method, the user can easily carry out a colour calibration of his colour monitor where necessary at any time. He simply has to aim the mobile device containing the colour sensor at the colour monitor during operation, in order to obtain one or multiple image recordings of the displayed image. By starting the measurement, for example by pressing a button on the unit, the colour correction described above is then carried out automatically. The mobile unit may also be a mobile phone, a smart phone or a tablet, for example, into which the colour sensor is integrated.

In the case of a television, the colour sensor is preferably integrated into the remote control of the colour television. The user simply aims the remote control with the colour sensor at the colour screen and triggers the measurement for colour calibration by pressing a key. By pressing the key, the colour television is actuated to display a suitable test image for colour calibration and the colour sensor then records a corresponding image for evaluation. Additional means, for example a positional sensor in the external unit, in particular the remote control, which assists the user in aligning the unit accurately for measuring, may be provided for the accurate recording of the test image using the colour sensor. In this case, corresponding aids may also be displayed on the colour television screen. For example, the image area just recorded by the colour sensor can be displayed on-screen in real time before the measurement begins. Markings which have to be brought into alignment when using a positional sensor by moving the unit, in order to achieve a precise alignment for the measurement, may also be shown in the on-screen image.

In one embodiment, the colour is only corrected in a portion of the image rather than the complete screen. This may be advantageous in cases in which colour distortion is only identified in an area of the screen. An ex-works calibration of the colour monitor can of course also take place using the proposed method.

The proposed method does not therefore require from the user any awkward positioning of a measuring unit on the screen. The user simply aims the unit with the colour sensor, for example a remote control, at the screen and carries out the measurement by the pressing of a button. In this way, colour calibration can easily be carried out at any time and repeated at arbitrary intervals. By means of the spatially resolved recording and evaluation of the image displayed on the colour monitor, the individual LED's or groups of LED's of the LED backlighting can be colour-corrected, so that no colour deviations occur between different areas. The method can of course also be used for other colour monitors, for example computer monitors. In this case, the external colour sensor can be integrated in a separate mobile unit or also in the computer mouse, for example, which then has to be aimed at the monitor for calibration.

In order to record the image displayed on the colour monitor, a suitable optical system is preferably mounted on or in front of the colour-measuring chip containing the colour sensor. By means of this optical system, the image displayed on the colour monitor is then mapped on the colour-measuring chip completely, for example. The colour sensor also records the ambient light through remote measurement, which ambient light is often a mixture of daylight and room lighting and in some cases is not distributed uniformly over the entire screen. An uneven distribution of this kind and the colour implications of this on the displayed image can likewise be corrected using the proposed method.

By comparison with the techniques known hitherto, the proposed method can be used for spatially resolved measurement and correction of the chromaticity coordinate over the entire screen. This is particularly advantageous for colour monitors which have LED backlighting. In this case, the lighting of the complete display is effected using LED arrays from behind, for example, also known as direct-LED principle or full-LED principle. With colour monitors of this kind, the image contrast due to local dimming of individual LED's or LED groups may be substantially greater in the dark areas of the image. When using the proposed method, the time-consuming selection of the same LED's for the LED backlighting (binning) which also generates higher costs can be dispensed with. Possibly different colour drifts between the individual LED's can easily be corrected by repeated colour calibrations.

The proposed colour monitor and colour-measuring sensor system accordingly comprises a colour monitor with LED backlighting in which the individual LED's or LED groups can be selectively changed in colour by means of a control device. A multi-channel colour-measuring sensor configured as an image or line sensor or forming an area of an image or line sensor, which colour-measuring sensor can distinguish between at least four colours in a spatially resolved manner, is integrated in a mobile unit in such a way that when the unit is aimed at the screen of the colour monitor, at least one area of the image can be spectrally recorded in a spatially resolved manner using the colour-measuring sensor. An evaluation device determines the colour deviations between the desired colour value of the displayed image and the colour values measured using the colour-measuring sensor. The evaluation device may be integrated in the mobile unit, the colour monitor or possibly in a unit comprising the control device. The evaluation device communicates these colour deviations or corresponding correction values to the control device for the LED backlighting, which then triggers the individual LED's or groups of LED's to correct the colour deviations. The mobile unit with the colour sensor is preferably connected to the evaluation device or the control device for the LED backlighting by a wireless connection. The proposed system is configured in preferred embodiments in such a way that it enables the process variants described above to be implemented in each case.

### BRIEF DESCRIPTION OF THE DRAWINGS

The proposed method and also the associated system are once again explained in greater detail below with the help of an exemplary embodiment in conjunction with the drawings. In the drawings:

FIG. 1 shows an example of the procedure involved in calibrating the colour of a colour television;

FIG. 2 shows a detail of a colour sensor which can be used in the proposed method and

FIG. 3 shows an example of the different components of a system for implementing the proposed method.

### WAYS OF IMPLEMENTING THE INVENTION

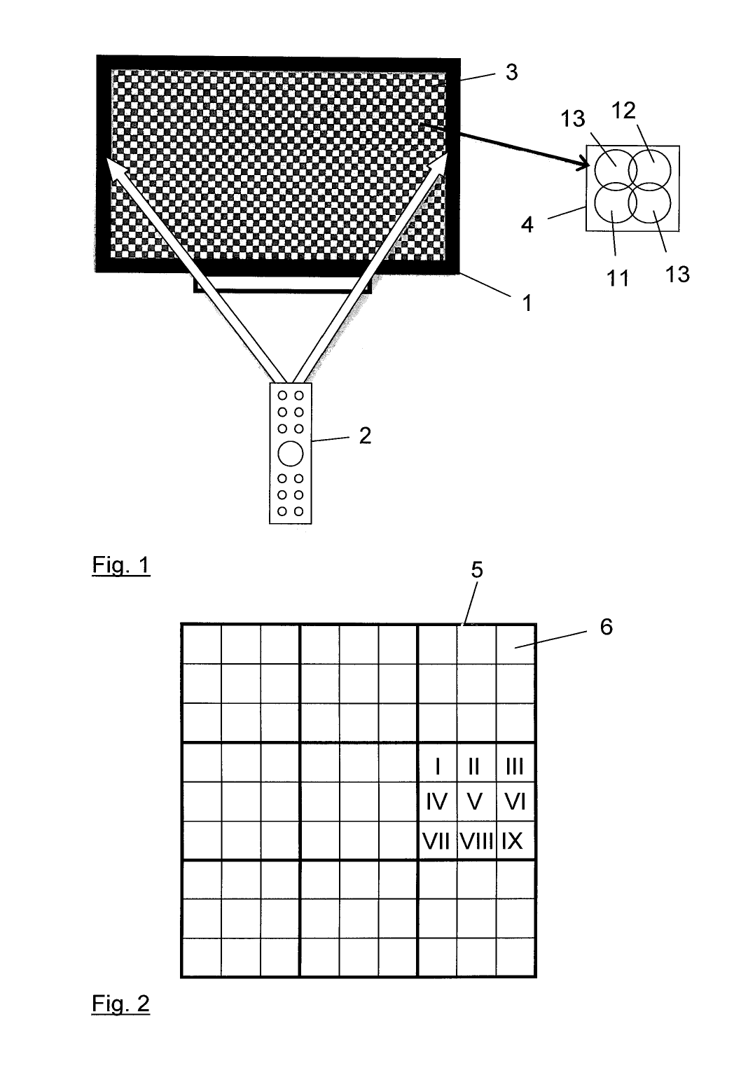

The proposed method for calibrating the colour of a colour television is once again explained in greater detail below. The basic idea behind the proposed method is that of locating a multi-channel colour-measuring chip, preferably configured as a colour sensor, in an external mobile unit and using it to record an area of the image displayed on the screen, preferably the complete image, from a distance of 1 to 5 metres, for example, and to evaluate it to determine colour deviations. In the present example, the colour-measuring chip is integrated in the remote control 2 of a colour television 1. In response to a command, for example a button being pressed by the user on the remote control, the television 1 sends a test image with a known desired colour distribution and the colour sensor performs a colour measurement of the test image. To do this, the user points the remote control 2 with the colour sensor at the television 1, in order to record the entire test image 3 displayed on the television 1 using the colour sensor. This is depicted schematically in FIG. 1. The image recorded or measured in this way is analysed either by the colour-measuring chip or another electronic component acting as the evaluation mechanism in the remote control, in order to be able to determine possible local colour deviations between the desired colour values of the desired colour distribution in the test image. The desired colour distribution of the test image in this case may be firmly specified in the remote control and the colour television, for example. It is also possible for the desired colour distribution of the test image to be transferred to the television via the remote control, said television then displaying the test image in accordance with these settings. In the case of a bidirectional connection between the remote control and the television, the desired colour distribution of the test image can also be communicated conversely from the television to the remote control or the electronic component or colour-measuring chip contained therein. During analysis, a colour deviation between the measured colour values and the desired colour values is determined in a spatially resolved manner. The relevant parameters for colour correction or colour adjustment are then transferred to the television and used there by the control device to actuate the LED backlighting for the spatially resolved correction of the colour display. Apart from colour correction, the proposed method can also be used to correct brightness deviations.

Transfer of the spatially resolved colour information or colour deviations preferably takes play via a wireless radio or IR interface, such as that already used in television remote controls. Alternatively, the colour information recorded using the colour-measuring chip or else the entire recorded image can of course also be transferred to the television and evaluated there in corresponding units.

The test image displayed by the television may be suitably selected, in order to obtain the best possible colour calibration over the entire recorded area. A finely structured test image is preferably used for this purpose, with which the entire screen area can be calibrated right into the corners. FIG. 1 shows an example of a chessboard pattern-like test image for this purpose with alternating black and white areas 4. The white areas 4 once again show a fine structure with a colour combination, due to the 4 respective LED's of the backlighting by means of which they are generated in this case. This is indicated in the enlarged portion of an area 4 of this kind in FIG. 1 by the light emission of the red LED 11, the blue LED 12 and the two green LED's 13.

A measurement involving the colour sensor in this case may be taken in such a manner that only the white and black areas 4 are resolved and tested for colour drift in respect of white or black. The measurement may, however, also be taken with a greater spatial resolution, in which case the colours of the individual LED's 11-13 can then also be measured.

This procedure may of course also be transferred to other colour monitors, for example computer monitors. In this case, the colour-measuring chip is then housed in a separate mobile unit which preferably communicates via an IR or radio connection with the colour monitor or a control for the colour monitor, for example in a computer. The colour-measuring chip may also be housed in a wired computer mouse or a radio mouse, for example, which the user then has to aim at the colour monitor in order to calibrate colours.

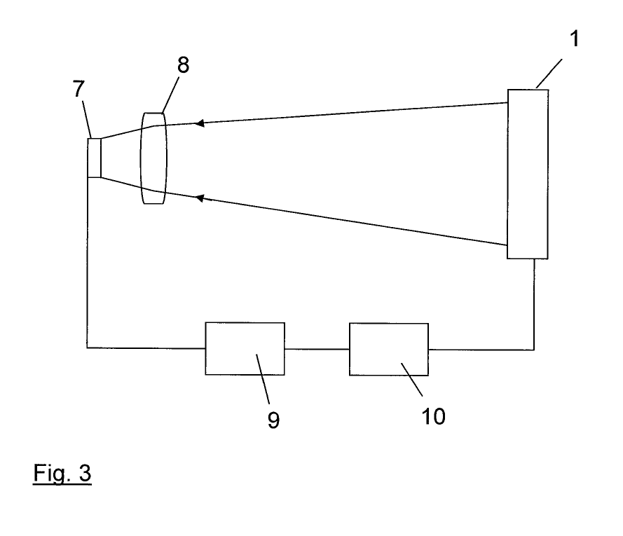

The colour-measuring chip is equipped with an image sensor in the proposed method, which image sensor is able to distinguish between at least four colours spectrally and in a spatially resolved manner and therefore determine the chromaticity coordinate of the television image more precisely. A nano-structured CMOS colour sensor or image sensor, for example, can be used for this purpose, which sensor exhibits an alternative pixel arrangement instead of the customary Bayer matrix with four sub-pixels, for example. The four sub-pixels in this case may be provided with different colour filters. In order to increase the quality further, a 9-channel field of sub-pixels can be used, as is depicted schematically in the detail from the image sensor in FIG. 2. Each measuring field 5 of this image sensor exhibits nine sub-pixels 6 in this case. The sub-pixels 6 of each measuring field 5 are equipped with a spectrally differently sensitive nanostructured metal layer as the colour filter, as is known from WO 2012/007147, for example. This is indicated using the Roman numerals I-IX in one of the measuring fields 5 in the representation in FIG. 2. The use of nano-structured metals to realize the image or colour sensor offers the advantage that the colour sensor can be produced alongside using a CMOS process at no additional cost, such as that normally used to produce a traditional image sensor. Instead of nano-structured metal layers, colour filters made up of dielectric layers can also be used.

The spatial resolution depends on the total number of measuring fields 5 in the colour-measuring chip and on whether the entire screen is mapped on this colour-measuring chip during the measurement or only an area thereof. The colour sensor or colour measuring chip should have at least a number of e.g. 4×3 measuring fields. When recording only an area that is smaller than the entire image of the colour monitor, the user can also scan the displayed image by hand using the mobile unit, so that the spatial resolution can thereby be increased, for example. The multiple images thereby created are then automatically used to assemble a complete image in the evaluation unit.

Apart from a two-dimensional image sensor, a line sensor can also be used as the colour sensor in the proposed method. However, this must then be guided by the user over the area to be measured, in order to record corresponding colour information over this area.

In one embodiment, the colour sensor may also capture only an area of the image or line sensor, for example a central area of the image sensor. This may also involve a colour sensor with only a large-area measuring field which then captures a correspondingly large area of the image sensor. For measuring purposes based on the image information, instructions such as arrows, for example, can be displayed on the screen for the user, indicating the direction in which he must move the mobile unit with the colour sensor for the measurement.

FIG. 3 shows by way of example different components of a system for implementing the proposed method. A system of this kind preferably comprises in addition to the colour-measuring chip 7, an optical arrangement 8 too for mapping the image displayed on the colour monitor 1 or an area of this image on the image recording surface of the colour-measuring chip 7. The system further comprises the evaluation device 9 which may be integrated in the colour-measuring chip 7, may be arranged separately from this in the mobile unit or may also be present on the colour monitor or in a computer connected thereto. This evaluation device 9 is connected to the control device 10 for actuating the LED backlighting of the colour monitor 1. The connections between the colour-measuring chip 7 and the evaluation device 9 and also between the evaluation device 9 and the control device 10 may be wired or wireless connections in each case.

When using the proposed method, in order to calibrate the user takes the remote control or corresponding mobile unit with the colour sensor arranged therein in his hand and positions himself so that the built-in camera or the built-in colour sensor records the desired area of the screen, preferably the entire screen. In an advantageous embodiment, the camera or else the colour-measuring sensor can transmit the recorded image to the colour monitor, so that said image is displayed in an area of the screen. Based on this representation, the user is able to identify an incorrect positioning and correct it easily. When an optimal position is reached, the user sees on the colour monitor that he can start calibration and presses a corresponding key. Optionally, a positional sensor may be installed alternatively or additionally in the remote control or the mobile unit, in order to show in the image displayed by the colour monitor, for example, the position at which the centre of the recorded image area lies or which image area is currently being recorded. A corresponding frame can also be displayed for this purpose. Likewise optionally, an optical or electrical image stabilizer can also be fitted in the mobile unit, in order to avoid camera shake during the colour measurement.

### LIST OF REFERENCE NUMBERS

1 Colour monitor/colour television
2 Remote control/mobile unit
3 Test image
4 Detail from test image
5 Measuring fields of the image or colour sensor
6 Sub-pixel of the image or colour sensor
7 Colour-measuring chip
8 Optical arrangement
9 Evaluation device
10 Control device
11 Red LED emission
12 Blue LED emission
13 Green LED emission

1. A method for calibrating the colour of a colour monitor with LED backlighting, comprising:
remotely measuring at least one area of an image displayed on the colour monitor in a spatially resolved manner using an image or line sensor configured at least in one area as a colour sensor, wherein a colour sensor is used which is able to distinguish at least four colours spectrally and in a spatially resolved manner,
determining spatially resolved deviations of measured colour values from desired colour values and
actuating the LED backlighting for local correction of the deviations.

2. The method according to claim 1,
characterized in that
during measurement using the colour sensor, a test image is displayed on the colour monitor which allows colour calibration.

3. The method according to claim 1,
characterized in that
using the colour sensor a complete image recording of the image displayed on the colour monitor is recorded.

4. The method according to claim 1,
characterized in that
using the colour sensor, multiple image recordings of different portions of the image displayed on the colour monitor are made, which are then used to assemble a complete image recording of the image displayed on the colour monitor.

5. The method according to claim 3,
further comprising:
transferring the image recording(s) to the colour monitor and determining the deviations by an evaluation device in the colour monitor (1).

6. The method according to claim 3
characterized in that
determining the deviations by an evaluation device in a mobile unit containing the colour sensor and information on the deviations or for correcting the deviations is then transferred to the colour monitor.

7. The method according to claim 5
further comprising:
wirelessly transferring the image recordings.

8. The method according to claim 1,
characterized in that
using an optical arrangement in front of the colour sensor, which optical arrangement maps the image displayed on the colour monitor or an area of this image during measurement on the colour sensor.

9. The method according to claim 1,
characterized in that
before measurement begins, an image just recorded by the colour sensor is displayed on the colour monitor, in order to allow precise alignment of the colour sensor for the measurement.

10. A system for calibrating the colour of a colour monitor which at least comprises a colour monitor with LED backlighting, a control device for controlled operation of the LED backlighting, a mobile unit with an image or line sensor configured at least in one area as a colour sensor and an evaluation device, wherein the colour sensor is configured in such a way that it is able to distinguish at least four colours spectrally and in a spatially resolved manner,
wherein the mobile unit is configured in such a manner that when the unit is aimed at the colour monitor at least one area of an image displayed on the colour monitor can be spectrally recorded remotely in a spatially resolved manner using the colour sensor,
wherein the evaluation device is configured in such a manner that it determines in a spatially resolved manner deviations between desired colour values of the recorded image and the colour values measured using the colour sensor and communicates deviations or correction values derived therefrom to the control device
and
wherein the control device is configured in such a manner that it actuates the LED backlighting based on the communicated deviations or correction values for local correction of the deviations.

11. The system according to claim 10
characterized in that
the mobile unit has an optical arrangement in front of the colour sensor, with which the image displayed on the colour monitor or an area of this image can be mapped on the colour sensor.

12. The system according to claim 10,
characterized in that
the evaluation mechanism is integrated into the mobile unit and communicates the deviations or correction values to the control device via a wireless connection.

13. The system according to claim 10,
characterized in that
the evaluation device is arranged in the colour monitor or a unit containing the control device and the mobile unit communicates the spatially resolved colour values measured using the colour sensor to the evaluation device via a wireless connection.

14. The system according to claim 10,
characterized in that
the colour monitor is a colour television and the colour sensor is integrated into a remote control of the colour television as a mobile unit.

15. The system according to claim 10,
characterized in that
the colour sensor has colour filters which are formed from nano-structured metal layers or from dielectric layers.

16. The method according to claim 8,
characterized in that
recording ambient light with the colour sensor through remote measurement, and colour implications of the ambient light on the displayed image are detected and corrected.
